(19) United States
(12) Patent Application Publication
(10) Pub. No.: US 2022/0414660 A1
(43) Pub. Date: Dec. 29, 2022

(54) TRANSACTION COMPLIANCE DETERMINATION USING MACHINE LEARNING

(71) Applicant: WARPSPEED, Inc, Pleasanton, CA (US)

(72) Inventor: Abnesh Raina, Pleasanton, CA (US)

(21) Appl. No.: 17/821,988

(22) Filed: Aug. 24, 2022

Related U.S. Application Data
(62) Division of application No. 17/303,873, filed on Jun. 9, 2021.

(51) Int. Cl. G06Q 20/40

(52) U.S. Cl. CPC G06Q 20/4015; G06Q 20/4016

(57) ABSTRACT

Disclosed are systems, methods, and non-transitory computer-readable media for determining compliance of a transaction using machine learning. A transaction compliance system automatically determines whether a requested transaction is in compliance with a set of compliance rules associated with the requested transaction. The set of compliance rules may be regional rules and regulations established by a governmental body and/or rules defined by a merchant. The transaction compliance system accesses the set of compliance rules corresponding to the transaction and determines whether the requested transaction is in compliance with the set of compliance rules. The requested transaction may be completed or denied based on the resulting output.

### CLAIM FOR PRIORITY

This application is a continuation of and claims the benefit of priority of U.S. application Ser. No. 17/303,873, filed Jun. 9, 2021, which is hereby incorporated by reference in its entirety.

### TECHNICAL FIELD

This document pertains generally, but not by way of limitation, to transactions and more specifically, to transaction compliance determination using machine learning.

### BACKGROUND

For the sale of particular goods there may be rules and regulations either placed on the sale of the product by a governmental body or by the seller. For example, certain medical supplies are only allowed to be purchased in particular amounts by a customer in order to be a legal sale.

Even on sales that are not regulated by a governmental body, there may be times when a seller wants to control the amount a customer can buy in a single sale based on the customers relations with the seller and the customer's transaction history.

Currently such checks are done manually to determine if a particular sale is in compliance with rules set by a regulatory authority. This becomes more complicated for particular products that have different regulations based on the location of the customer and the seller. Strict compliance with regulations can be challenging and even cost prohibitive for a business to implement in manual manner. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows a system for transaction compliance determination using machine learning, according to some example embodiments.

FIG. 2 is a block diagram of a transaction compliance system, according to some example embodiments.

FIG. 3 is a block diagram of a compliance determination component, according to some example embodiments.

FIG. 4 is a flowchart showing a method for transaction compliance determination using machine learning, according to some example embodiments.

FIG. 5 is a flowchart showing a method for providing recommended modifications to a requested transaction for compliance with a set of compliance rules, according to some example embodiments.

FIG. 6 is a flowchart showing a method for determining whether a transaction complies with a set of compliance rules based on a compliance score, according to some example embodiments.

FIG. 7 is a flowchart showing a method for determining whether a transaction complies with a set of compliance rules based on a consumer score, according to some example embodiments.

FIG. 8 is a flowchart showing a method for determining whether a transaction complies with a set of compliance rules based on a cumulative score, according to some example embodiments.

FIG. 9 is a block diagram illustrating a representative software architecture, which may be used in conjunction with various hardware architectures herein described.

FIG. 10 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for transaction compliance determination using machine learning. A transaction compliance system automatically determines whether a requested transaction is in compliance with a set of compliance rules associated with the requested transaction. The set of compliance rules may be regional rules and regulations established by a governmental body and/or rules defined by a merchant.

As explained earlier, the sale of particular goods may be regulated by a governmental body and/or by a merchant. Currently, the process of ensuring that purchases are in compliance with compliance rules is performed manually. This is both time consuming and challenging, particularly when dealing with products that are governed with different compliance rules based on geographic region. To alleviate these issues, a transaction compliance system automatically determines whether a requested transaction complies with the appropriate set of compliance rules. For example, the transaction compliance system maintains sets of compliance rules associated with various products, geographic regions, and/or merchants. When a user requests to complete a transaction, transaction data describing the requested transaction is provided to the transaction compliance system. The transaction compliance system accesses the set of compliance rules corresponding to the transaction and determines whether the requested transaction is in compliance with the set of compliance rules.

The requested transaction may be completed or denied based on the resulting output. For example, if the requested transaction complies with the set of compliance rules, the transaction compliance system provides a response to complete the transaction. Alternatively, if the requested transaction does not comply with the set of compliance rules, the transaction compliance system provides a response to deny the transaction. In some embodiments, the transaction compliance system provides a recommended modification to place the requested transaction into compliance with the set of compliance rules. For example, the transaction compliance system may identify potential modifications to the requested transaction and recommend one or more of the potential modifications that presents a minimal differential from the originally requested transaction.

The transaction compliance system may determine whether a requested transaction compiles with the set of compliance rules in various ways. For example, the transaction compliance system may determine a compliance score for the requested transaction that indicates the likelihood that the requested transaction complies with the set of compliance rules. The compliance score may be determined based on the transaction data describing the requested transaction and the corresponding set of compliance rules. The transaction compliance system compares the compliance score to a threshold compliance score to determine whether the requested transaction complies with the set of compliance rules.

In some embodiments, the transaction compliance system uses a customer score to determine whether a requested transaction compiles with the set of compliance rules. The customer score may be determined based consumer data associated with a customer requesting the transaction, such as historical transaction data describing previous transactions performed by the customer. The transaction compliance system compares the customer score to a threshold customer score to determine whether the requested transaction complies with the set of compliance rules.

The transaction compliance system may determine the compliance scores and/or customer scores using various algorithms and/or machine learning models. For example, the transaction compliance system may train machine learning models based on training data comprised of historical transaction data and/or consumer data. The transaction compliance system may generate separate machine learning models to calculate the compliance scores and the customer scores. The transaction compliance system may determine whether a transaction complies with a set of compliance rules based on one or both of the compliance score and the customer score. For example, the transaction compliance system may generate an aggregated score based on the compliance score and the customer score, which is compared to a threshold aggregated score to determine whether the requested transaction complies with the set of compliance rules. In some embodiments, the aggregated score may be determined using a separate machine learning model that was trained based compliance scores and customer scores determined from the historical transaction data and/or consumer data.

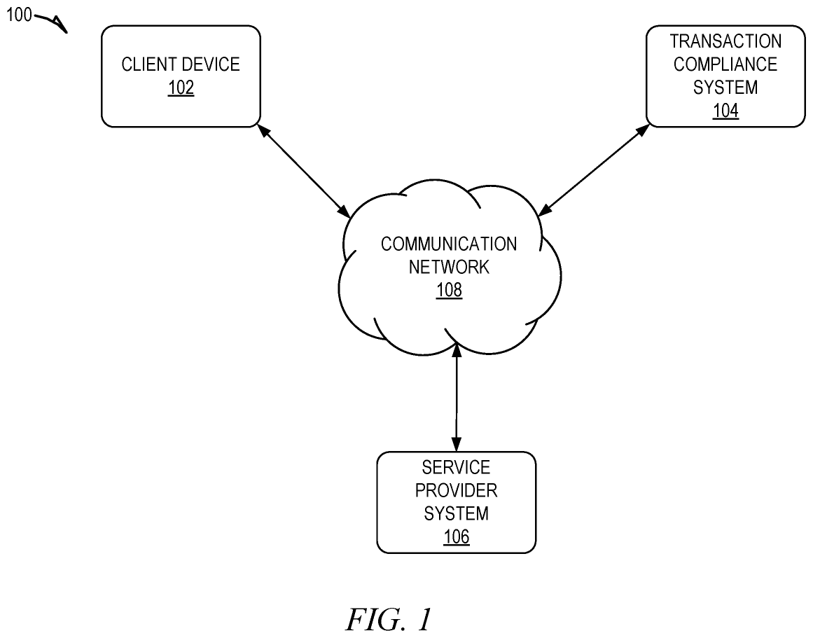

FIG. 1 shows a system 100 for transaction compliance determination using machine learning, according to some example embodiments. As shown, the system 100 includes multiple devices (i.e., client device 102, transaction compliance system 104, and service provider system 106) are connected to a communication network 108 and configured to communicate with each other through use of the communication network 108. The communication network 108 is any type of network, including a local area network (LAN), such as an intranet, a wide area network (WAN), such as the internet, a telephone and mobile device network, such as cellular network, or any combination thereof. Further, the communication network 108 may be a public network, a private network, or a combination thereof. The communication network 108 is implemented using any number of communication links associated with one or more service providers, including one or more wired communication links, one or more wireless communication links, or any combination thereof. Additionally, the communication network 108 is configured to support the transmission of data formatted using any number of protocols.

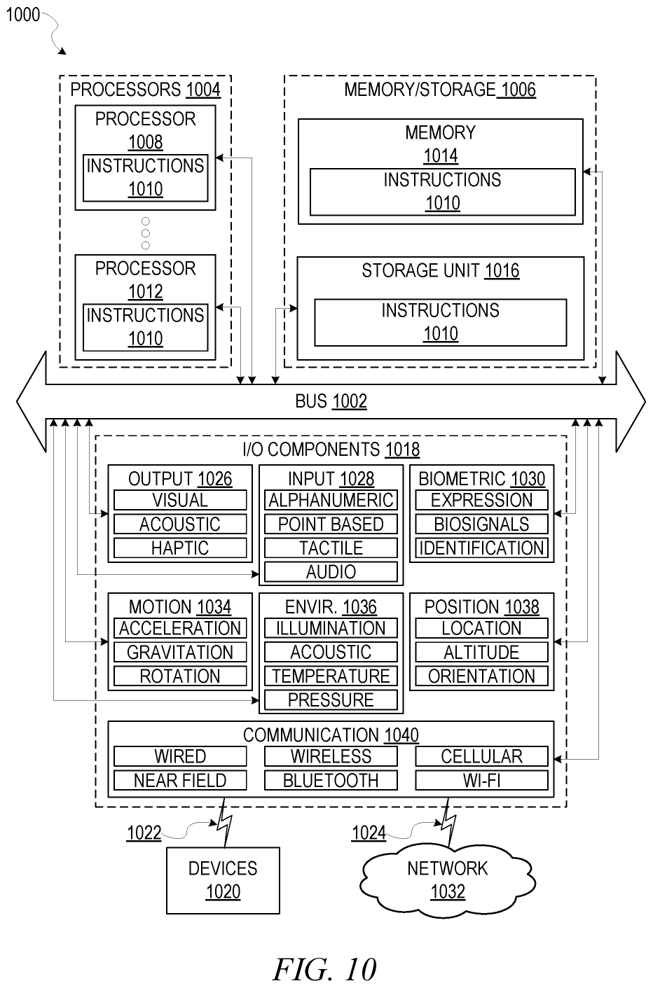

Multiple computing devices can be connected to the communication network 108. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 1000 shown in FIG. 10.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

The service provider system 106 is one or more computing devices associated with a service provider. A service provider may be a person, business, company, and/or any other type of entity that provides a service. For example, the service provider may provide a service such as a banking service, travel service, retail service, and the like. The service may be an online and/or offline service. That is, the service may be available only online, such as an online retailer, offline, such as a physical retailer, or both online and offline, such as a retailer that provides a website or application as well as a physical retail store.

The service provider system 106 may facilitate any portion of the service that is provided online, such as a ride-sharing service, reservation service, retail service, news service, and the like. In these types of embodiments, users (e.g., customers of the service provider) may interact with the service provider system 106 to utilize the online service provided by the service provider. For example, users communicate with and utilize the functionality of the service provider system 106 by using a client device 102 connected to the communication network 108 by direct and/or indirect communication.

A user may interact with the service provider system 106 via a client-side application installed on the client device 102. In some embodiments, the client-side application includes a component specific to the service provider system 106. For example, the component may be a stand-alone application, one or more application plug-ins, and/or a browser extension. However, users may also interact with the service provider system 106 via a third-party application, such as a web browser or messaging application, that resides on the client devices 102 and 104 and is configured to communicate with the service provider system 106. In either case, the client-side application presents a user interface (UI) for the user to interact with the service provider system 106. For example, the user interacts with the service provider system 106 via a client-side application integrated with the file system or via a webpage displayed using a web browser application.

In some embodiments, the service provider system 106 does not provide an online service. For example, the service provider system 106 may simply be a computing system used by a service provider to perform any type of functionality, such as manage inventory, maintain transaction data, maintain customer records, and the like. As another example, the service provider system 106 may be used in conjunction with an offline service, such as those provided at a brick and mortar location. For example, the service provider system 106 may include point-of-sale devices that are located at brick and mortar locations to facilitate the sale of items.

Although the shown system 100 includes only one client device 102 and one service provider system 106, this is only for ease of explanation and is not meant to be limiting. The system 100 can include any number of client devices 102 and/or service provider systems 106. Further, each service provider system 106 may concurrently accept communications from and/or interact with any number of client devices 102 and support connections from a variety of different types of client devices 102, such as desktop computers; mobile computers; mobile communications devices, e.g., mobile phones, smart phones, tablets; smart televisions; set-top boxes; and/or any other network enabled computing devices. Hence, the client device 102 may be of varying type, capabilities, operating systems, and so forth.

The service provider system 106 may facilitate various transaction provided by the service provider. A transaction may be any of a variety of types of transactions, such as purchasing items, transferring monetary funds, and the like. Sometimes sales are required to be regulated by compliance rules.

As explained earlier, the sale of particular goods may be regulated by a governmental body and/or by a merchant. For example, a governmental body may define compliance rules that place restrictions on the number and/or amount of an item that that may be purchased. Currently, the process of ensuring that purchases are in compliance with compliance rules is performed manually. This is both time consuming and challenging, particularly when dealing with products that are governed with different compliance rules based on geographic region.

To alleviate these issues, the service provider system 106 utilizes the functionality of a transaction compliance system 104 that automatically determines whether a requested transaction complies with the appropriate set of compliance rules. For example, the transaction compliance system 104 maintains sets of compliance rules associated with various products, geographic regions, and/or merchants. When a user requests to complete a transaction, the service provider system 106 provides transaction data describing the requested transaction to the transaction compliance system 104. The transaction compliance system 104 accesses the set of compliance rules corresponding to the requested transaction and determines whether the requested transaction is in compliance with the set of compliance rules.

The requested transaction may be completed or denied based on the resulting output. For example, if the requested transaction complies with the set of compliance rules, the transaction compliance system 104 provides the service provider system 106 with a response to complete the transaction. Alternatively, if the requested transaction does not comply with the set of compliance rules, the transaction compliance system 104 provides the service provider system 106 with a response to deny the transaction.

In some embodiments, the transaction compliance system 104 provides a recommended modification to place the requested transaction into compliance with the set of compliance rules. For example, the transaction compliance system 104 may identify potential modifications to the requested transaction and recommend one or more of the potential modifications that presents a minimal differential from the originally requested transaction. The transaction compliance system 104 provides the recommended modifications to the service provider system 106 and/or a client device 102 of the requesting user. This provides the user with data indicating how the requested transaction can be modified to comply with the set of compliance rules.

The transaction compliance system 104 may determine whether a requested transaction compiles with the set of compliance rules in various ways. For example, the transaction compliance system 104 may determine a compliance score for the requested transaction that indicates the likelihood that the requested transaction complies with the set of compliance rules. The compliance score may be determined based on the transaction data describing the requested transaction and the corresponding set of compliance rules. The transaction compliance system 104 compares the compliance score to a threshold compliance score to determine whether the requested transaction complies with the set of compliance rules.

In some embodiments, the transaction compliance system 104 uses a customer score to determine whether a requested transaction compiles with the set of compliance rules. The customer score may be determined based consumer data associated with a customer requesting the transaction, such as historical transaction data describing previous transactions performed by the customer. The transaction compliance system 104 compares the customer score to a threshold customer score to determine whether the requested transaction complies with the set of compliance rules.

The transaction compliance system 104 may determine the compliance scores and/or customer scores using various algorithms and/or machine learning models. For example, the transaction compliance system 104 may train machine learning models based on training data comprised of historical transaction data and/or consumer data. The transaction compliance system 104 may generate separate machine learning models to calculate the compliance scores and the customer scores. The transaction compliance system 104 may determine whether a transaction complies with a set of compliance rules based on one or both of the compliance score and the customer score. For example, the transaction compliance system 104 may generate an aggregated score based on the compliance score and the customer score, which is compared to a threshold aggregated score to determine whether the requested transaction complies with the set of compliance rules. In some embodiments, the aggregated score may be determined using a separate machine learning model that was trained based compliance scores and customer scores determined from the historical transaction data and/or consumer data.

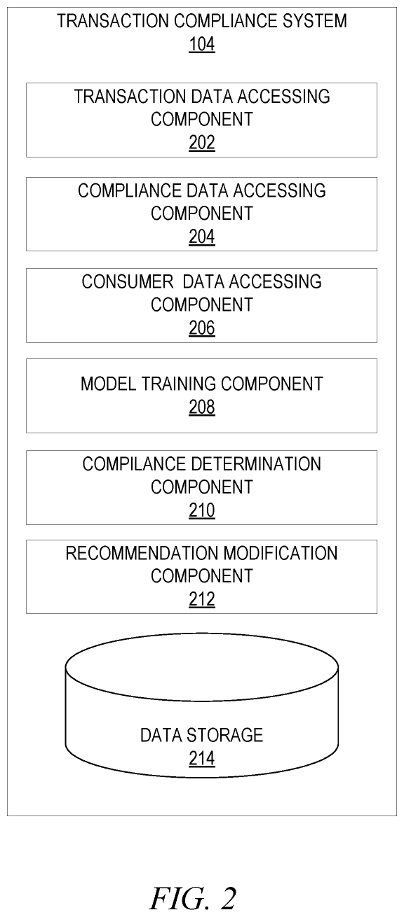

FIG. 2 is a block diagram of a transaction compliance system 104, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the transaction compliance system 104 to facilitate additional functionality that is not specifically described herein. Furthermore, the various functional modules depicted in FIG. 2 may reside on a single computing device or may be distributed across several computing devices in various arrangements such as those used in cloud-based architectures.

As shown the transaction compliance system 104 includes a transaction data accessing component 202, a compliance data accessing component 204, a consumer data accessing component 206, a model training component 208, a compliance determination component 210, recommendation modification component 212, and a data storage 214.

The transaction data accessing component 202 accesses transaction data describing a requested transaction. For example, the transaction data may include data describing a set of items to be purchased and the quantities of the items that are to be purchased. The transaction data may also include data identifying the user requesting the transaction (e.g., buyer), the service provider (e.g., merchant) associated with the transaction, the location of the user and/or service provider, and the like.

The transaction data accessing component 202 may access the transaction data from the service provider system 106. For example, the service provider system 106 may transmit the transaction data to the transaction compliance system 104 upon a user requesting to perform a transaction, such as by requesting to purchase items. The transaction data accessing component 202 receives the transaction data and may provide the transaction data to any of the other components within the transaction compliance system 104 and/or store the transaction data in the data storage 214.

The compliance data accessing component 204 accesses a set of compliance rules based on a requested transaction. As explained earlier, the sale of particular goods may be regulated by a governmental body and/or by a merchant. For example, a governmental body may define a set of compliance rules that place restrictions on the number and/or amount of an item that that may be purchased. As another example, a merchant may define a set of compliance rules that places restrictions on the number and/or amount of an item that that may be purchased at a particular store or within a given time frame.

The compliance data accessing component 204 accesses a set of compliance rules that corresponds to a requested transaction. For example, the compliance data accessing component 204 may access a set of compliance rules that correspond to a geographic region associated with the requested transaction, the service provider (e.g., merchant), and the like.

The compliance data accessing component 204 accesses the set of compliance rules from the data storage 214. The data storage 214 may maintain various sets of compliance rules corresponding to various geographic regions, governmental bodies, service providers, and the like. The compliance data accessing component 204 uses data included in the transaction data accessed by the transaction data accessing component 202 to search the data storage 214 for the appropriate set of compliance rules. For example, the compliance data accessing component 204 may use data defining a geographic region of the requesting user and/or service provider system 106 to search for a set of compliance rules corresponding to the geographic region. As another example, the compliance data accessing component 204 may use data identifying the service provider system 106 to search for a set of compliance rules corresponding to the service provider.

The compliance data accessing component 204 may provide the set of compliance rules to any of the other components within the transaction compliance system 104.

The consumer data accessing component 206 accesses consumer data corresponding to the user requesting to perform the requested transaction. The consumer data includes data identifying the user, previous interactions associated with the user, and/or personal data associated with the user. For example, the consumer data can include data that identifies the user, such as the user's name, an account identifier associated with the user, the user's address, phone number, email address, payment information (e.g., credit card number, bank account) and the like.

The consumer data may also include a interaction history describing previous transactions performed by the user, stores visited by the user, websites viewed by the user, and the like. This may include previous interactions with a particular merchant or a group of merchants.

The consumer data may also include personal data associated with the user. The personal data may include confidential and/or sensitive data associated with the user, such as the user's medical history, medical prescriptions provided to the user, and the like.

The consumer data accessing component 206 may access the consumer data from the service provider system 106 or from the data storage 214. For example, the service provider system 106 may provide consumer data to the transaction compliance system 104 upon a user requesting to perform a transaction, such as purchasing items. Additionally, the consumer data accessing component 206 may query the service provider system 106 for the consumer data. For example, the consumer data accessing component 206 may provide the service provider system 106 with an identifier associated with the user as part of the query, which the service provider system 106 uses to access the corresponding consumer data. To access consumer data from the data storage 214, the consumer data accessing component 206 may execute a search based on an identifier associated with the user.

The consumer data accessing component 206 may provide the consumer data to the other components of the transaction compliance system 104. In some embodiments, consumer data may include personal data that is governed under specified guidelines and standards. For example, access to medical data and payment information are governed by standards such as the Health Insurance Portability and Accountability Act (HIPPA) and the Payment Card Industry (PCI) Data Security Standard. The consumer data accessing component 206 may access and/or handle personal data in a manner that complies with these standards, such as by controlling where that personal data is sent, limiting access to the personal data, and the like. For example, medical information that is controlled under HIPPA guidelines may be shared in a limited manner with the other components of the transaction compliance system 104, but access to the personal data may be restricted from the service provider system 106. The personal data may also be anonymized and/or stored in a manner that adheres to consumer privacy laws.

The model training component 208 trains machine learning models used to determine whether a requested transaction is in compliance with a set of compliance rules. For example, the trained machine learning models may receive an input based on transaction data, consumer data, and/or set of compliance rules, and provide an output probability value indicating the likelihood that the requested transaction is in compliance with the set of compliance rules.

The model training component 208 may train a machine learning model based on training data describing previous transactions that has been labeled to indicate whether the previous transaction was or was not in compliance with the set of compliance rules. The training data may be comprised of historical transaction data and/or consumer data associated with each of the previous transaction.

In some embodiments, the model training component 208 generates representative vectors based on a set of predefined features extracted from the training data. The resulting representative vectors are used to train the machine learning model. Once trained, the resulting machine learning model provides an output probability value based on an input vector generated based on a similar set of features extracted from the transaction data and/or consumer data associated with a requested transaction.

The model training component 208 may generate multiple machine learning models based on different types of training data. For example, the model training component 208 may generate a machine learning model based on transaction data describing individual transactions, as well as another machine learning model based on a transaction data describing a series of transactions and/or consumer data associated with a requesting user. The model training component 208 may also generate different machine learning models for different sets of compliance rules. For example, the model training component 208 may generated machine a machine learning model for a set of compliance rules based on transaction data and/or consumer data that relates to requested transactions that are governed by the set of compliance rules.

In some embodiments, the model training component 208 generates a machine learning model that determines a likelihood that a transaction complies with a set of compliance rules based on the requested transaction. For example, the model training component 208 may train the machine learning model based on transaction data describing individual transactions. Once trained, the resulting machine learning model receives an input generated from transaction data describing a requested transaction and outputs a compliance score indicating the likelihood that a requested transaction complies with a set of compliance rules.

In some embodiments, the model training component 208 generates a machine learning model that determines a likelihood that a transaction complies with a set of compliance rules based on data describing a user that requested the transaction. For example, the model training component 208 may train the machine learning model based on consumer data associated with users that requested transaction and/or transaction data describing a series of transactions requested by the user. Once trained, the resulting machine learning model receives an input generated from the consumer data and/or transaction data describing a series of transactions and outputs a consumer score indicating the likelihood that a requested transaction complies with a set of compliance rules.

In some embodiments, the model training component 208 generates a machine learning model that determines a likelihood that a transaction complies with a set of compliance rules based on multiple probability scores output by other machine learning models. For example, the model training component 208 may train the machine learning model based on transaction scores and consumer scores generated from historical transaction data and/or consumer data. Once trained, the resulting machine learning model receives an input generated from a transaction score and consumer score determined for a requested transaction and outputs a cumulative score indicating the likelihood that a requested transaction complies with a set of compliance rules.

The compliance determination component 210 determines whether a requested transaction is in compliance with a set of compliance rules. For example, the compliance determination component uses the transaction data and/or consumer data associated with the requested transaction to generate inputs for one or more of the machine learning models generated by the model training component 208.

The compliance determination component 210 provides each generated input to the corresponding machine learning model to generate a probability value that the requested transaction complies with the set of compliance rules. For example, the compliance determination component 210 may generate an input based on transaction data describing the requested transaction and provide the input to a machine learning model that was trained based on historical transaction data describing individual transaction, resulting in a compliance score. The compliance determination component 210 may similarly generate an input based on consumer data describing the requesting user and/or transaction data describing a series of transaction associated with the user and provide the input to a machine learning model that was trained based on consumer data and/or historical transaction data describing a series of transaction, resulting in a consumer score.

The compliance determination component 210 may also generate a cumulative input based on the resulting probability scores (e.g., compliance score and consumer score) generated from other machine learning models. The compliance determination component 210 may use the cumulative input as input into a machine learning model trained based on probability values, resulting cumulative score indicating a likelihood that the requested transaction complies with the set of compliance rules.

In any case, the compliance determination component 210 compares the resulting probability value (e.g., compliance score, consumer score, cumulative score) to a threshold probability value to determine whether the requested transaction complies with the set of compliance rules. For example, the compliance determination component 210 determines that the requested transaction complies with the set of compliance rules if the probability value meets or exceed a threshold value. Alternatively, the compliance determination component 210 determines that the requested transaction does not comply with the set of compliance rules if the probability value does not meet or exceed the threshold value (e.g., is below the threshold value).

The requested transaction may be completed or denied based on the resulting output if the compliance determination component 210. For example, if the compliance determination component 210 determines that the requested transaction complies with the set of compliance rules, the transaction compliance system 104 provides a response to the service provider system 106 (e.g., point of sale device) indicating that the transactions should be completed. Alternatively, if the compliance determination component 210 determines that the requested transaction does not comply with the set of compliance rules, the transaction compliance system 104 provides a response to the service provider system 106 (e.g., point of sale device) indicating that the transactions should be denied.

In the event that a requested transaction does not comply with the set of compliance rules, the transaction compliance system 104 may provide the service provider system 106 with a recommended modification to the requested transaction to bring the requested in transaction into compliance with the set of compliance rules. The recommendation modification may indicate a change the requested transactions, such as by modifying a quantity of items, combination of items, strengths of items, and the like.

The recommendation modification component 212 determines a recommended modification for a requested transaction that does complies with a set of compliance rules. The recommendation modification component 212 may determine the recommended modifications using various techniques, such as by modifying the items, quantities and/or strengths of items included in the requested transaction to cause the probability score associated with the requested transaction to increase above a threshold probability score.

In some embodiments, the recommendation modification component 212 may determine a recommended modification that provides a minimal modification to the requested transaction. For example, the recommendation modification component 212 may identify as set of potential modifications to the requested transaction and rank the potential modifications based on a differential between each recommended modification and the requested transaction. The recommendation modification component 212 may select a recommended modification based on the ranking to provide the user with a recommended modification that presents a minimal differential from the originally requested transaction. For example, the recommendation modification component 212 may select the recommended modification that is ranked highest or a recommended modification that is ranked within a specified range, such as withing the top five.

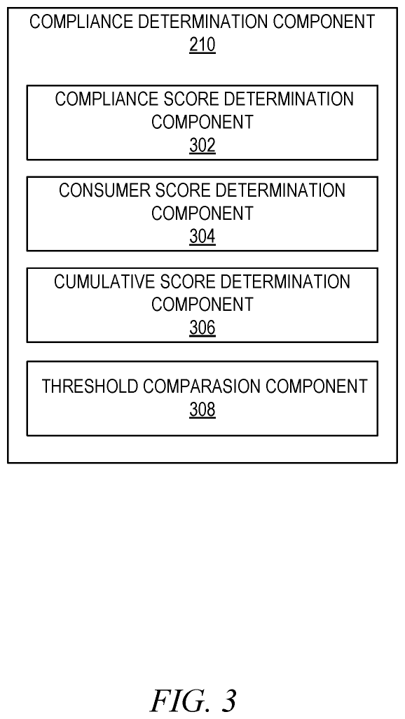

FIG. 3 is a block diagram of a compliance determination component 210, according to some example embodiments. To avoid obscuring the inventive subject matter with unnecessary detail, various functional components (e.g., modules) that are not germane to conveying an understanding of the inventive subject matter have been omitted from FIG. 3. Furthermore, the various functional modules depicted in FIG. 3 may reside on a single computing device or may be distributed across several computing devices in various arrangements such as those used in cloud-based architectures.

As shown the compliance determination component 210 includes a compliance score determination component 302, a consumer score determination component 304, a cumulative score determination component 306, and a threshold comparison component 308.

The compliance score determination component 302 determines a compliance score indicating the likelihood that a requested transaction complies with a set of compliance rules. The compliance score is based on data describing the requested transaction. For example, the compliance score may be based on transaction data describing the requested transaction, such as the items being purchased, quantities of items, strengths of items, and the like.

The compliance score determination component 302 generates an input based on the transaction data. For example, the compliance score determination component 302 may generate a vector representation of the transaction data based on predetermined features from the transaction data. The compliance score determination component 302 may then provide the input (e.g., feature vector) into the corresponding machine learning model. For example, the machine learning model may have been trained based on similar vectors generated from historical transaction data. The machine learning model returns a compliance score indicating the likelihood that that the requested transaction complies with the set of compliance rules.

The consumer score determination component 304 determines a consumer score indicating the likelihood that the requested transaction complies with the set of compliance rules. The consumer score may be generated by based on consumer data describing the requesting user and/or transaction data describing a series of transaction associated with the requesting user. For example, the consumer score determination component 304 generates an input (e.g., feature vector) based on the consumer data describing the requesting user and/or transaction data describing a series of transaction associated with the requesting user and provide the input to a machine learning model that was trained based on similar training data (e.g., consumer data and/or historical transaction data describing a series of transactions). The machine learning model outputs the consumer score based on the provide input.

The cumulative score determination component 306 generate a cumulative input based on the resulting probability scores (e.g., compliance score and consumer score) generated from other machine learning models. The cumulative score determination component 306 may use the cumulative input as input into a machine learning model trained based on probability values determines using machine learning modes. The machine learning model provides a cumulative score indicating a likelihood that the requested transaction complies with the set of compliance rules based on the provided input.

The threshold comparison component 308 compares a resulting probability value (e.g., compliance score, consumer score, cumulative score) to a threshold probability value to determine whether the requested transaction complies with the set of compliance rules. The threshold comparison component 308 may use a singular threshold value or differing threshold values for the different types of probability values. The threshold comparison component 308 determines that a requested transaction complies with the set of compliance rules if the probability value meets or exceed a threshold value. Alternatively, the threshold comparison component 308 determines that the requested transaction does not comply with the set of compliance rules if the probability value does not meet or exceed the threshold value (e.g., is below the threshold value).

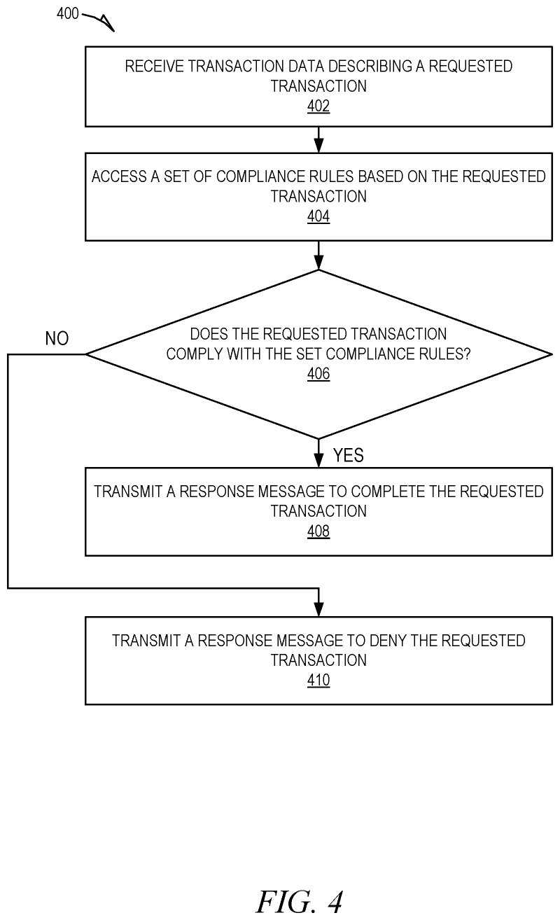

FIG. 4 is a flowchart showing a method for transaction compliance determination using machine learning, according to some example embodiments. The method 400 may be embodied in computer readable instructions for execution by one or more processors such that the operations of the method 400 may be performed in part or in whole by the transaction compliance system 104; accordingly, the method 400 is described below by way of example with reference thereto. However, it shall be appreciated that at least some of the operations of the method 400 may be deployed on various other hardware configurations and the method 400 is not intended to be limited to the transaction compliance system 104.

At operation 402, the transaction data accessing component 202 receives transaction data describing a requested transaction. The transaction data accessing component 202 accesses transaction data describing a requested transaction. For example, the transaction data may include data describing a set of items to be purchased and the quantities of the items that are to be purchased. The transaction data may also include data identifying the user requesting the transaction (e.g., buyer), the service provider (e.g., merchant) associated with the transaction, the location of the user and/or service provider, and the like.

The transaction data accessing component 202 may access the transaction data from the service provider system 106. For example, the service provider system 106 may transmit the transaction data to the transaction compliance system 104 upon a user requesting to perform a transaction, such as by requesting to purchase items. The transaction data accessing component 202 receives the transaction data and may provide the transaction data to any of the other components within the transaction compliance system 104 and/or store the transaction data in the data storage 214.

At operation 404, the compliance data accessing component 204 accesses a set of compliance rules based on the requested transaction. The compliance data accessing component 204 accesses a set of compliance rules based on a requested transaction. As explained earlier, the sale of particular goods may be regulated by a governmental body and/or by a merchant. For example, a governmental body may define a set of compliance rules that place restrictions on the number and/or amount of an item that that may be purchased. As another example, a merchant may define a set of compliance rules that places restrictions on the number and/or amount of an item that that may be purchased at a particular store or within a given time frame.

The compliance data accessing component 204 accesses a set of compliance rules that corresponds to a requested transaction. For example, the compliance data accessing component 204 may access a set of compliance rules that correspond to a geographic region associated with the requested transaction, the service provider (e.g., merchant), and the like.

The compliance data accessing component 204 accesses the set of compliance rules from the data storage 214. The data storage 214 may maintain various sets of compliance rules corresponding to various geographic regions, governmental bodies, service providers, and the like. The compliance data accessing component 204 uses data included in the transaction data accessed by the transaction data accessing component 202 to search the data storage 214 for the appropriate set of compliance rules. For example, the compliance data accessing component 204 may use data defining a geographic region of the requesting user and/or service provider system 106 to search for a set of compliance rules corresponding to the geographic region. As another example, the compliance data accessing component 204 may use data identifying the service provider system 106 to search for a set of compliance rules corresponding to the service provider.

The compliance data accessing component 204 may provide the set of compliance rules to any of the other components within the transaction compliance system 104.

At operation 406, the compliance determination component 210 determines whether the requested transaction complies with the set of compliance rules. The compliance determination component 210 determines whether a requested transaction is in compliance with a set of compliance rules. For example, the compliance determination component uses the transaction data and/or consumer data associated with the requested transaction to generate inputs for one or more of the machine learning models generated by the model training component 208.

The compliance determination component 210 provides each generated input to the corresponding machine learning model to generate a probability value that the requested transaction complies with the set of compliance rules. For example, the compliance determination component 210 may generate an input based on transaction data describing the requested transaction and provide the input to a machine learning model that was trained based on historical transaction data describing individual transaction, resulting in a compliance score. The compliance determination component 210 may similarly generate an input based on consumer data describing the requesting user and/or transaction data describing a series of transaction associated with the user and provide the input to a machine learning model that was trained based on consumer data and/or historical transaction data describing a series of transaction, resulting in a consumer score.

The compliance determination component 210 may also generate a cumulative input based on the resulting probability scores (e.g., compliance score and consumer score) generated from other machine learning models. The compliance determination component 210 may use the cumulative input as input into a machine learning model trained based on probability values, resulting cumulative score indicating a likelihood that the requested transaction complies with the set of compliance rules.

In any case, the compliance determination component 210 compares the resulting probability value (e.g., compliance score, consumer score, cumulative score) to a threshold probability value to determine whether the requested transaction complies with the set of compliance rules. For example, the compliance determination component 210 determines that the requested transaction complies with the set of compliance rules if the probability value meets or exceed a threshold value. Alternatively, the compliance determination component 210 determines that the requested transaction does not comply with the set of compliance rules if the probability value does not meet or exceed the threshold value (e.g., is below the threshold value).

The requested transaction may be completed or denied based on the resulting output if the compliance determination component 210. For example, if the compliance determination component 210 determines that the requested transaction complies with the set of compliance rules, at operation 408, the transaction compliance system 104 transmits a response message to complete the requested transaction. Alternatively, if the compliance determination component 210 determines that the requested transaction does not comply with the set of compliance rules, at operation 410, the transaction compliance system 104 transmits a response message to deny the requested transaction.

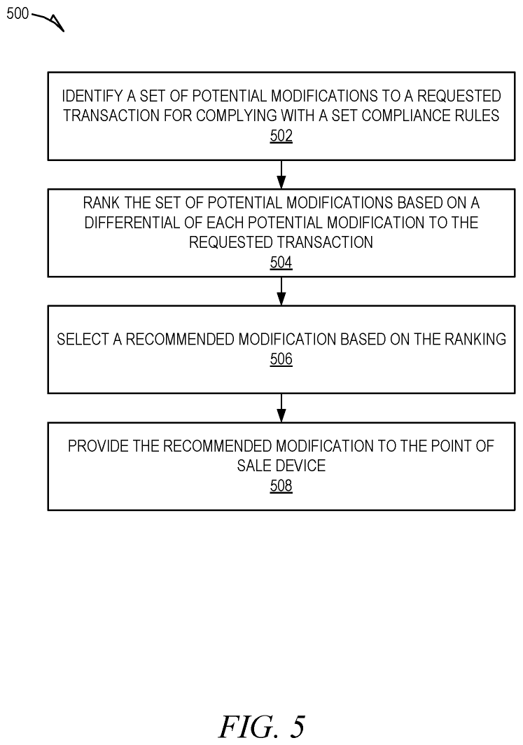

FIG. 5 is a flowchart showing a method for providing recommended modifications to a requested transaction for compliance with a set of compliance rules, according to some example embodiments. The method 500 may be embodied in computer readable instructions for execution by one or more processors such that the operations of the method 500 may be performed in part or in whole by the transaction compliance system 104; accordingly, the method 500 is described below by way of example with reference thereto. However, it shall be appreciated that at least some of the operations of the method 500 may be deployed on various other hardware configurations and the method 500 is not intended to be limited to the transaction compliance system 104.

At operation 502, the recommendation modification component 212 identifies a set of potential modifications to a requested transaction for complying with a set of compliance rules. In the event that a requested transaction does not comply with a set of compliance rules, a recommended modification can be returned to the user. The recommendation modification may indicate a change the requested transactions to bring the requested transaction into compliance with the set of compliance rules. For example, the recommended modification may be a modification to the quantity of items, combination of items, strengths of items, and the like, included in the requested transaction.

The recommendation modification component 212 may determine the recommended modifications using various techniques, such as by modifying the items, quantities and/or strengths of items included in the requested transaction to cause the probability score associated with the requested transaction to increase above a threshold probability score.

In some embodiments, the recommendation modification component 212 may determine a recommended modification that provides a minimal modification to the requested transaction. To accomplish this, at operation 504, the recommendation modification component 212 ranks the set of potential modifications based on a differential of each potential modification to the requested transaction, and at operation 506, the recommendation modification component 212 selects a recommended modification based on the ranking. For example, the recommendation modification component 212 may select the recommended modification that is ranked highest or a recommended modification that is ranked within a specified range, such as within the top five.

After selecting a recommended modification, at operation 508, the recommendation modification component 212 provides the recommended modification to the point of sale device. The user attempting to perform the requested transaction may choose to implement the recommended modification to bring the requested transaction into compliance with the set of compliance rules.

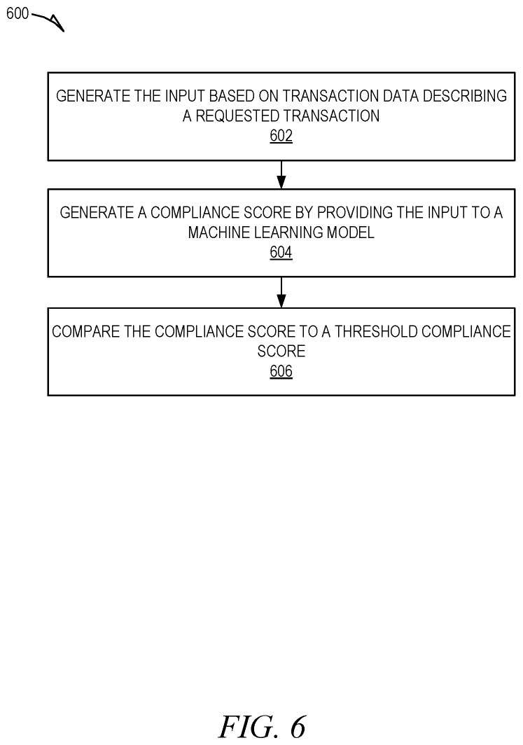

FIG. 6 is a flowchart showing a method for determining whether a transaction complies with a set of compliance rules based on a compliance score, according to some example embodiments. The method 600 may be embodied in computer readable instructions for execution by one or more processors such that the operations of the method 600 may be performed in part or in whole by the transaction compliance system 104; accordingly, the method 600 is described below by way of example with reference thereto. However, it shall be appreciated that at least some of the operations of the method 600 may be deployed on various other hardware configurations and the method 600 is not intended to be limited to the transaction compliance system 104.

At operation 602, the compliance score determination component 302 generates an input based on transaction data describing the requested transaction. The compliance score determination component 302 generates an input based on the transaction data. For example, the compliance score determination component 302 may generate a vector representation of the transaction data based on predetermined features from the transaction data.

At operation 604, the compliance score determination component 302 generates a compliance score by providing the input to a machine learning model. The compliance score determination component 302 determines a compliance score indicating the likelihood that a requested transaction complies with a set of compliance rules. The compliance score determination component 302 may provide the input to a machine learning model that was trained based on historical transaction data describing individual transactions, resulting in a compliance score. The machine learning model may have been trained based on similar vectors generated from historical transaction data. The machine learning model returns a compliance score indicating the likelihood that that the requested transaction complies with the set of compliance rules.

At operation 606, the threshold comparison component 308 compares the compliance score to a threshold compliance score. The threshold comparison component 308 compares the compliance score to the threshold compliance to determine whether the requested transaction complies with the set of compliance rules. The threshold comparison component 308 determines that a requested transaction complies with the set of compliance rules if the compliance score meets or exceed the threshold compliance score. The requested transaction may be allowed based on the resulting output of the threshold comparison component 308.

Alternatively, the threshold comparison component 308 determines that the requested transaction does not comply with the set of compliance rules if the compliance score does not meet or exceed the threshold compliance score. The requested transaction may be denied based on the resulting output of the threshold comparison component 308.

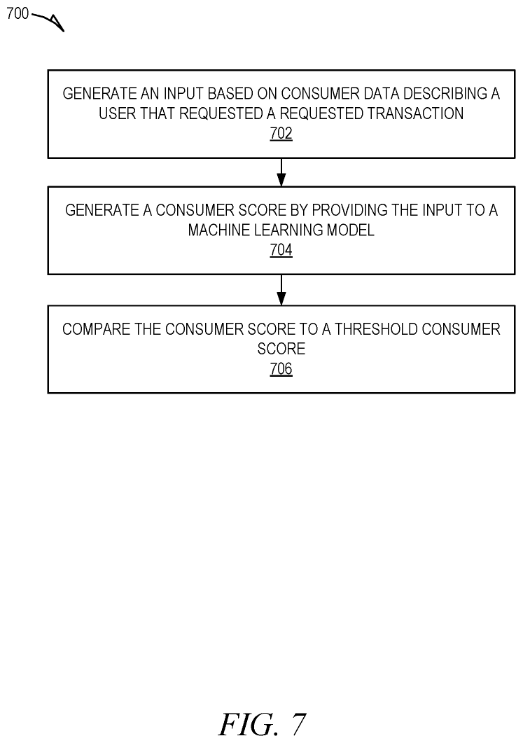

FIG. 7 is a flowchart showing a method for determining whether a transaction complies with a set of compliance rules based on a consumer score, according to some example embodiments. The method 700 may be embodied in computer readable instructions for execution by one or more processors such that the operations of the method 700 may be performed in part or in whole by the transaction compliance system 104; accordingly, the method 700 is described below by way of example with reference thereto. However, it shall be appreciated that at least some of the operations of the method 700 may be deployed on various other hardware configurations and the method 700 is not intended to be limited to the transaction compliance system 104.

At operation 702, the consumer score determination component 304 generates an input based on consumer data describing a user that requested a requested transaction. The consumer data describes the requesting user and/or transaction data describing a series of transaction associated with the requesting user. For example, the compliance score determination component 302 may generate a vector representation of the consumer data based on predetermined features from the consumer data.

At operation 704, the consumer score determination component 304 generates a consumer score by providing the input to a machine learning model. The machine learning model outputs the consumer score based on the provided input. The machine learning model may have been trained based on similar training data (e.g., consumer data and/or historical transaction data describing a series of transactions). The machine learning model used by the consumer score determination component 304 returns a compliance score indicating the likelihood that the requested transaction complies with the set of compliance rules.

At operation 706, the threshold comparison component 308 compares the consumer score to a threshold consumer score. The threshold comparison component 308 compares the resulting consumer score to the threshold consumer score to determine whether the requested transaction complies with a set of compliance rules. The threshold comparison component 308 determines that a requested transaction complies with the set of compliance rules if consumer score meets or exceed the threshold consumer score. In this case, the compliance determination component 210 provides a response to the service provider system 106 (e.g., point of sale device) indicating that the transactions should be completed.

Alternatively, if the threshold comparison component 308 determines that the requested transaction does not meet or exceed the threshold consumer score, the compliance determination component 210 determines that the requested transaction does not comply with the set of compliance rules. In this case, the compliance determination component 210 provides a response to the service provider system 106 (e.g., point of sale device) indicating that the transactions should be denied.

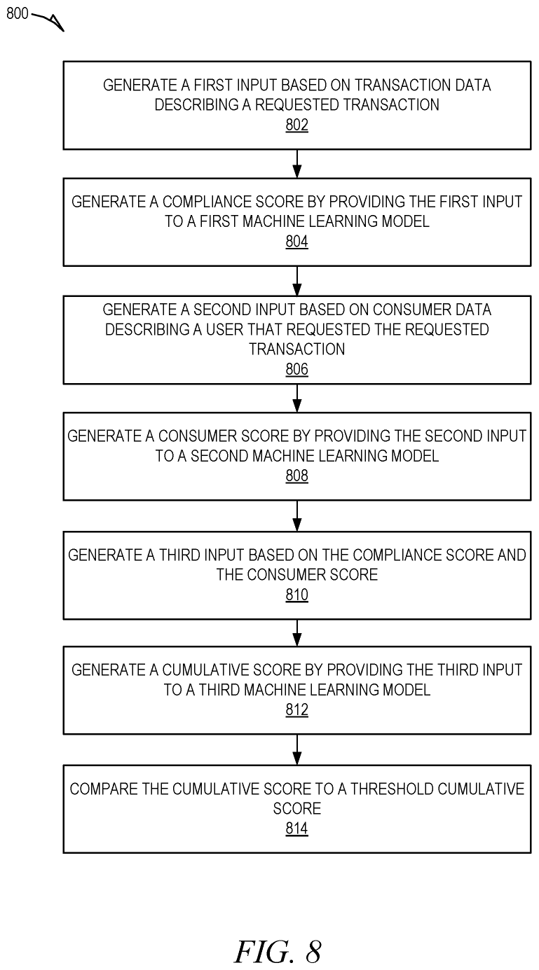

FIG. 8 is a flowchart showing a method for determining whether a transaction complies with a set of compliance rules based on a cumulative score, according to some example embodiments. The method 800 may be embodied in computer readable instructions for execution by one or more processors such that the operations of the method 800 may be performed in part or in whole by the transaction compliance system 104; accordingly, the method 800 is described below by way of example with reference thereto. However, it shall be appreciated that at least some of the operations of the method 800 may be deployed on various other hardware configurations and the method 800 is not intended to be limited to the transaction compliance system 104.

At operation 802, the compliance score determination component 302 generates a first input based on transaction data describing a requested transaction. For example, the compliance score may be based on transaction data describing the requested transaction, such as the items being purchased, quantities of items, strengths of items, and the like.

At operation 804, the compliance score determination component 302 generates a compliance score by providing the first input to a first machine learning model. The compliance score indicates the likelihood that the requested transaction complies with a set of compliance rules. The first machine learning model outputs the compliance score based on the first input.

At operation 806, the consumer score determination component 304 generates a second input based on consumer data describing a user that requested the requested transaction. The consumer score may be generated by based on consumer data describing the requesting user and/or transaction data describing a series of transaction associated with the requesting user.

At operation 808, the consumer score determination component 304 generates a consumer score by providing the second input to a second machine learning model. The consumer score indicates the likelihood that the requested transaction complies with the set of compliance rules. The second machine learning model outputs the consumer score based on the provided second input.

At operation 810, the cumulative score determination component 306 generates a third input based on the compliance score and the consumer score. For example, the cumulative score determination component 306 may generate the cumulative input be aggregating the compliance score and the consumer score. Additionally or alternatively, the cumulative score determination component 306 may generate a feature vector by extracting features from the compliance score and the consumer score.

At operation 812, the cumulative score determination component 306 generates a cumulative score by providing the third input to a third machine learning model. The cumulative score indicates a likelihood that the requested transaction complies with the set of compliance rules based on the provided input.

At operation 814, the threshold comparison component 308 compares the cumulative score to a threshold cumulative score. The threshold comparison component 308 compares the cumulative score to the threshold cumulative score to determine whether the requested transaction complies with the set of compliance rules. The threshold comparison component 308 determines that a requested transaction complies with the set of compliance rules if the cumulative score meets or exceed a threshold cumulative score. Alternatively, the threshold comparison component 308 determines that the requested transaction does not comply with the set of compliance rules if the cumulative score does not meet or exceed the threshold cumulative score (e.g., is below the threshold cumulative score).

### Software Architecture

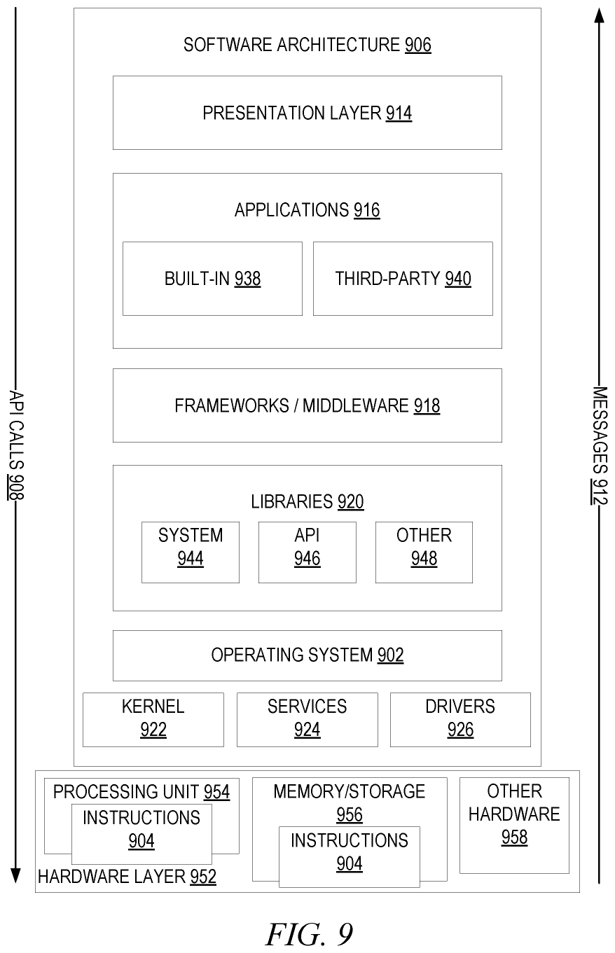

FIG. 9 is a block diagram illustrating an example software architecture 906, which may be used in conjunction with various hardware architectures herein described. FIG. 9 is a non-limiting example of a software architecture 906 and it will be appreciated that many other architectures may be implemented to facilitate the functionality described herein. The software architecture 906 may execute on hardware such as machine 1000 of FIG. 10 that includes, among other things, processors 1004, memory 1014, and (input/output) I/O components 1018. A representative hardware layer 952 is illustrated and can represent, for example, the machine 1000 of FIG. 10. The representative hardware layer 952 includes a processing unit 954 having associated executable instructions 904. Executable instructions 904 represent the executable instructions of the software architecture 906, including implementation of the methods, components, and so forth described herein. The hardware layer 952 also includes memory and/or storage modules 956, which also have executable instructions 904. The hardware layer 952 may also comprise other hardware 958.

In the example architecture of FIG. 9, the software architecture 906 may be conceptualized as a stack of layers where each layer provides particular functionality. For example, the software architecture 906 may include layers such as an operating system 902, libraries 920, frameworks/middleware 918, applications 916, and a presentation layer 914. Operationally, the applications 916 and/or other components within the layers may invoke application programming interface (API) calls 908 through the software stack and receive a response such as messages 912 in response to the API calls 908. The layers illustrated are representative in nature and not all software architectures have all layers. For example, some mobile or special purpose operating systems may not provide a frameworks/middleware 918, while others may provide such a layer. Other software architectures may include additional or different layers.

The operating system 902 may manage hardware resources and provide common services. The operating system 902 may include, for example, a kernel 922, services 924, and drivers 926. The kernel 922 may act as an abstraction layer between the hardware and the other software layers. For example, the kernel 922 may be responsible for memory management, processor management (e.g., scheduling), component management, networking, security settings, and so on. The services 924 may provide other common services for the other software layers. The drivers 926 are responsible for controlling or interfacing with the underlying hardware. For instance, the drivers 926 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 920 provide a common infrastructure that is used by the applications 916 and/or other components and/or layers. The libraries 920 provide functionality that allows other software components to perform tasks in an easier fashion than to interface directly with the underlying operating system 902 functionality (e.g., kernel 922, services 924, and/or drivers 926). The libraries 920 may include system libraries 944 (e.g., C standard library) that may provide functions such as memory allocation functions, string manipulation functions, mathematical functions, and the like. In addition, the libraries 920 may include API libraries 946 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 920 may also include a wide variety of other libraries 948 to provide many other APIs to the applications 916 and other software components/modules.

The frameworks/middleware 918 (also sometimes referred to as middleware) provide a higher-level common infrastructure that may be used by the applications 916 and/or other software components/modules. For example, the frameworks/middleware 918 may provide various graphical user interface (GUI) functions, high-level resource management, high-level location services, and so forth. The frameworks/middleware 918 may provide a broad spectrum of other APIs that may be used by the applications 916 and/or other software components/modules, some of which may be specific to a particular operating system 902 or platform.

The applications 916 include built-in applications 938 and/or third-party applications 940. Examples of representative built-in applications 938 may include, but are not limited to, a contacts application, a browser application, a book reader application, a location application, a media application, a messaging application, and/or a game application. Third-party applications 940 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 940 may invoke the API calls 908 provided by the mobile operating system (such as operating system 902) to facilitate functionality described herein.

The applications 916 may use built in operating system functions (e.g., kernel 922, services 924, and/or drivers 926), libraries 920, and frameworks/middleware 918 to create UIs to interact with users of the system. Alternatively, or additionally, in some systems, interactions with a user may occur through a presentation layer, such as presentation layer 914. In these systems, the application/component “logic” can be separated from the aspects of the application/component that interact with a user.

FIG. 10 is a block diagram illustrating components of a machine 1000, according to some example embodiments, able to read instructions 904 from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1010 (e.g., software, a program, an application, an applet, an app, or other executable code) for causing the machine 1000 to perform any one or more of the methodologies discussed herein may be executed. As such, the instructions 1010 may be used to implement modules or components described herein. The instructions 1010 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 1000 capable of executing the instructions 1010, sequentially or otherwise, that specify actions to be taken by machine 1000. Further, while only a single machine 1000 is illustrated, the term “machine” shall also be taken to include a collection of machines that individually or jointly execute the instructions 1010 to perform any one or more of the methodologies discussed herein.

The machine 1000 may include processors 1004, memory/storage 1006, and I/O components 1018, which may be configured to communicate with each other such as via a bus 1002. The memory/storage 1006 may include a memory 1014, such as a main memory, or other memory storage, and a storage unit 1016, both accessible to the processors 1004 such as via the bus 1002. The storage unit 1016 and memory 1014 store the instructions 1010 embodying any one or more of the methodologies or functions described herein. The instructions 1010 may also reside, completely or partially, within the memory 1014, within the storage unit 1016, within at least one of the processors 1004 (e.g., within the processor's cache memory), or any suitable combination thereof, during execution thereof by the machine 1000. Accordingly, the memory 1014, the storage unit 1016, and the memory of processors 1004 are examples of machine-readable media.

The I/O components 1018 may include a wide variety of components to receive input, provide output, produce output, transmit information, exchange information, capture measurements, and so on. The specific I/O components 1018 that are included in a particular machine 1000 will depend on the type of machine. For example, portable machines such as mobile phones will likely include a touch input device or other such input mechanisms, while a headless server machine will likely not include such a touch input device. It will be appreciated that the I/O components 1018 may include many other components that are not shown in FIG. 10. The I/O components 1018 are grouped according to functionality merely for simplifying the following discussion and the grouping is in no way limiting. In various example embodiments, the I/O components 1018 may include output components 1026 and input components 1028. The output components 1026 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1028 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1018 may include biometric components 1030, motion components 1034, environmental components 1036, or position components 1038 among a wide array of other components. For example, the biometric components 1030 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1034 may include acceleration sensor components (e.g., accelerometer), gravitation sensor components, rotation sensor components (e.g., gyroscope), and so forth. The environmental components 1036 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1038 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1018 may include communication components 1040 operable to couple the machine 1000 to a network 1032 or devices 1020 via coupling 1024 and coupling 1022, respectively. For example, the communication components 1040 may include a network interface component or other suitable device to interface with the network 1032. In further examples, communication components 1040 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1020 may be another machine or any of a wide variety of peripheral devices (e.g., a peripheral device coupled via a USB).

Moreover, the communication components 1040 may detect identifiers or include components operable to detect identifiers. For example, the communication components 1040 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040 such as location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 1010 for execution by the machine 1000, and includes digital or analog communications signals or other intangible medium to facilitate communication of such instructions 1010. Instructions 1010 may be transmitted or received over the network 1032 using a transmission medium via a network interface device and using any one of a number of well-known transfer protocols.

“CLIENT DEVICE” in this context refers to any machine 1000 that interfaces to a communications network 1032 to obtain resources from one or more server systems or other client devices. A client device may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 1032.

“COMMUNICATIONS NETWORK” in this context refers to one or more portions of a network 1032 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 1032 or a portion of a network 1032 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 1010 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 1010. The term “machine-readable medium” shall also be taken to include any medium, or combination of multiple media, that is capable of storing instructions 1010 (e.g., code) for execution by a machine 1000, such that the instructions 1010, when executed by one or more processors 1004 of the machine 1000, cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 1004) may be configured by software (e.g., an application 916 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 1004 or other programmable processor 1004. Once configured by such software, hardware components become specific machines 1000 (or specific components of a machine 1000) uniquely tailored to perform the configured functions and are no longer general-purpose processors 1004. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 1004 configured by software to become a special-purpose processor, the general-purpose processor 1004 may be configured as respectively different special-purpose processors (e.g., comprising different hardware components) at different times. Software accordingly configures a particular processor or processors 1004, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 1002) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 1004 that are temporarily configured (e.g., by software) or permanently configured to perform the relevant operations. Whether temporarily or permanently configured, such processors 1004 may constitute processor-implemented components that operate to perform one or more operations or functions described herein. As used herein, “processor-implemented component” refers to a hardware component implemented using one or more processors 1004. Similarly, the methods described herein may be at least partially processor-implemented, with a particular processor or processors 1004 being an example of hardware. For example, at least some of the operations of a method may be performed by one or more processors 1004 or processor-implemented components. Moreover, the one or more processors 1004 may also operate to support performance of the relevant operations in a “cloud computing” environment or as a “software as a service” (SaaS). For example, at least some of the operations may be performed by a group of computers (as examples of machines 1000 including processors 1004), with these operations being accessible via a network 1032 (e.g., the Internet) and via one or more appropriate interfaces (e.g., an API). The performance of certain of the operations may be distributed among the processors 1004, not only residing within a single machine 1000, but deployed across a number of machines 1000. In some example embodiments, the processors 1004 or processor-implemented components may be located in a single geographic location (e.g., within a home environment, an office environment, or a server farm). In other example embodiments, the processors 1004 or processor-implemented components may be distributed across a number of geographic locations.

“PROCESSOR” in this context refers to any circuit or virtual circuit (a physical circuit emulated by logic executing on an actual processor 1004) that manipulates data values according to control signals (e.g., “commands,” “op codes,” “machine code,” etc.) and which produces corresponding output signals that are applied to operate a machine 1000. A processor 1004 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor 1004 may further be a multi-core processor having two or more independent processors 1004 (sometimes referred to as “cores”) that may execute instructions 1010 contemporaneously.

1. A method comprising:
receiving, by one or more processors and from a point of sale device, transaction data describing a requested transaction, the transaction data describing a set of items to be purchased;
accessing, by the one or more processors, a set of compliance rules corresponding to a geographic region associated with the requested transaction;
determining a compliance score indicating a likelihood that the requested transaction complies with the set of compliance rules based on the transaction data describing the requested transaction, wherein the compliance score is determined using the transaction data as input into a first machine learning model trained based on historical transaction data;
determining a consumer score indicating a likelihood that the requested transaction complies with the set of compliance rules based on consumer data describing a user that initiated the requested transaction, wherein the consumer score is determined using the consumer data as input into a second machine learning model trained based on historical consumer data;
determining, based on the compliance score and the consumer score, that the requested transaction does not comply with the set of compliance rules corresponding to the geographic region;
determining, based on the transaction data and the set of compliance rules, a recommended modification to the set of items to comply with the set of compliance rules corresponding to the geographic region; and
providing the recommended modification to the point of sale device.

2. The method of claim 1, further comprising:
in response to the determining that the requested transaction does not comply with the set of compliance rules corresponding to the geographic region, transmitting a message to the point of sale device to deny the requested transaction.

3. The method of claim 1, wherein determining the recommended modification comprises:
identifying a set of potential modifications to comply with the set of compliance rules corresponding to the geographic region;
ranking the set of potential modifications based on a determined differential of each potential modification to the requested transaction; and
selecting the recommended modification based on the ranking.

4. The method of claim 1, further comprising:
receiving, from a second point of sale device, second transaction data describing a second requested transaction, the second transaction data describing a second set of items to be purchased;
accessing a second set of compliance rules corresponding to a second geographic region associated with the second requested transaction;
determining, based on the second transaction data and the second set of compliance rules, that the second requested transaction complies with the second set of compliance rules corresponding to the second geographic region; and
in response to determining that the second requested transaction complies with the set of compliance rules corresponding to the geographic region, transmitting a message to the point of sale device to complete the second requested transaction.

5. The method of claim 1, wherein determining whether the requested transaction complies with the set of compliance rules corresponding to the geographic region further comprises:
generating a cumulative input based on the compliance score and the consumer score;
providing the cumulative input to a third machine learning model trained based on historical compliance scores and historical consumer scores, the third machine learning model outputting a cumulative probability score indicating a likelihood that the requested transaction complies with the set of compliance rules; and
determining whether the requested transaction complies with the set of compliance rules based on the cumulative probability score.

6. The method of claim 1, wherein the recommended modification comprises modifying a quantity of items in the set of items to be purchased.

7. The method of claim 1, wherein the recommended modification comprises modifying a strength of an item in the set of items to be purchased.

8. A system comprising:
one or more computer processors; and
one or more computer-readable mediums storing instructions that, when executed by the one or more computer processors, causes the system to perform operations comprising:
receiving, from a point of sale device, transaction data describing a requested transaction, the transaction data describing a set of items to be purchased;
accessing a set of compliance rules corresponding to a geographic region associated with the requested transaction;
determining a compliance score indicating a likelihood that the requested transaction complies with the set of compliance rules based on the transaction data describing the requested transaction, wherein the compliance score is determined using the transaction data as input into a first machine learning model trained based on historical transaction data;
determining a consumer score indicating a likelihood that the requested transaction complies with the set of compliance rules based on consumer data describing a user that initiated the requested transaction, wherein the consumer score is determined using the consumer data as input into a second machine learning model trained based on historical consumer data;
determining, based on the compliance score and the consumer score, that the requested transaction does not comply with the set of compliance rules corresponding to the geographic region;
determining, based on the transaction data and the set of compliance rules, a recommended modification to the set of items to comply with the set of compliance rules corresponding to the geographic region; and
providing the recommended modification to the point of sale device.

9. The system of claim 8, wherein the operations further comprise:
in response to the determining that the requested transaction does not comply with the set of compliance rules corresponding to the geographic region, transmitting a message to the point of sale device to deny the requested transaction.

10. The system of claim 8, wherein determining the recommended modification comprises:
identifying a set of potential modifications to comply with the set of compliance rules corresponding to the geographic region;
ranking the set of potential modifications based on a determined differential of each potential modification to the requested transaction; and
selecting the recommended modification based on the ranking.

11. The system of claim 8, wherein the operations further comprise:
receiving, from a second point of sale device, second transaction data describing a second requested transaction, the second transaction data describing a second set of items to be purchased;
accessing a second set of compliance rules corresponding to a second geographic region associated with the second requested transaction;
determining, based on the second transaction data and the second set of compliance rules, that the second requested transaction complies with the second set of compliance rules corresponding to the second geographic region; and
in response to determining that the second requested transaction complies with the set of compliance rules corresponding to the geographic region, transmitting a message to the point of sale device to complete the second requested transaction.

12. The system of claim 8, wherein determining whether the requested transaction complies with the set of compliance rules corresponding to the geographic region further comprises:
generating a cumulative input based on the compliance score and the consumer score;
providing the cumulative input to a third machine learning model trained based on historical compliance scores and historical consumer scores, the third machine learning model outputting a cumulative probability score indicating a likelihood that the requested transaction complies with the set of compliance rules; and
determining whether the requested transaction complies with the set of compliance rules based on the cumulative probability score.

13. The system of claim 8, wherein the recommended modification comprises modifying a quantity of items in the set of items to be purchased.

14. The system of claim 8, wherein the recommended modification comprises modifying a strength of an item in the set of items to be purchased.

15. A non-transitory computer-readable medium storing instructions that, when executed by one or more computer processors of one or more computing devices, cause the one or more computing devices to perform operations comprising:
receiving, from a point of sale device, transaction data describing a requested transaction, the transaction data describing a set of items to be purchased;
accessing a set of compliance rules corresponding to a geographic region associated with the requested transaction;
determining a compliance score indicating a likelihood that the requested transaction complies with the set of compliance rules based on the transaction data describing the requested transaction, wherein the compliance score is determined using the transaction data as input into a first machine learning model trained based on historical transaction data;
determining a consumer score indicating a likelihood that the requested transaction complies with the set of compliance rules based on consumer data describing a user that initiated the requested transaction, wherein the consumer score is determined using the consumer data as input into a second machine learning model trained based on historical consumer data;
determining, based on the compliance score and the consumer score, that the requested transaction does not comply with the set of compliance rules corresponding to the geographic region;
determining, based on the transaction data and the set of compliance rules, a recommended modification to the set of items to comply with the set of compliance rules corresponding to the geographic region; and
providing the recommended modification to the point of sale device.

16. The non-transitory computer-readable medium of claim 15, wherein the operations further comprise:
in response to the determining that the requested transaction does not comply with the set of compliance rules corresponding to the geographic region, transmitting a message to the point of sale device to deny the requested transaction.

17. The non-transitory computer-readable medium of claim 15, wherein determining the recommended modification comprises:
identifying a set of potential modifications to comply with the set of compliance rules corresponding to the geographic region;
ranking the set of potential modifications based on a determined differential of each potential modification to the requested transaction; and
selecting the recommended modification based on the ranking.

18. The non-transitory computer-readable medium of claim 15, wherein the operations further comprise:
receiving, from a second point of sale device, second transaction data describing a second requested transaction, the second transaction data describing a second set of items to be purchased;
accessing a second set of compliance rules corresponding to a second geographic region associated with the second requested transaction;
determining, based on the second transaction data and the second set of compliance rules, that the second requested transaction complies with the second set of compliance rules corresponding to the second geographic region; and
in response to determining that the second requested transaction complies with the set of compliance rules corresponding to the geographic region, transmitting a message to the point of sale device to complete the second requested transaction.

19. The non-transitory computer-readable medium of claim 15, wherein determining whether the requested transaction complies with the set of compliance rules corresponding to the geographic region further comprises:
generating a cumulative input based on the compliance score and the consumer score;
providing the cumulative input to a third machine learning model trained based on historical compliance scores and historical consumer scores, the third machine learning model outputting a cumulative probability score indicating a likelihood that the requested transaction complies with the set of compliance rules; and
determining whether the requested transaction complies with the set of compliance rules based on the cumulative probability score.

20. The non-transitory computer-readable medium of claim 15, wherein the recommended modification comprises modifying a quantity of items in the set of items to be purchased.
